(19) United States
(12) Patent Application Publication
(10) Pub. No.: US 2026/0094985 A1
(43) Pub. Date: Apr. 2, 2026

(54) ELECTRICAL CONNECTOR FOR CIRCUIT BOARD

(71) Applicant: HIROSE ELECTRIC CO., LTD., Kanagawa (JP)

(72) Inventor: Kentaro DOI, Kanagawa (JP)

(21) Appl. No.: 19/337,383

(22) Filed: Sep. 23, 2025

(30) Foreign Application Priority Data
Sep. 27, 2024 (JP) 2024-168390

(51) Int. Cl. H01R 12/71; H01R 12/91

(52) U.S. Cl. CPC H01R 12/716; H01R 12/91

(57) ABSTRACT

An electrical connector for a circuit board, disposed on a mounting surface of the circuit board, to which a counterpart connector is fitted and connected, the electrical connector includes: a plurality of terminals having a shape in which a metal plate member is bent in a plate thickness direction and disposed in an attitude in which a plate thickness surface is perpendicular to the mounting surface; and a housing that holds the plurality of terminals, in which the housing includes a fixed housing fixed to the circuit board via the terminal, and a movable housing relatively movable with respect to the fixed housing.

### CROSS-REFERENCE TO RELATED APPLICATION

This application claims priority from Japanese Patent Application No. 2024-168390 filed with the Japan Patent Office on September 27, 2024, the entire content of which is hereby incorporated by reference.

### BACKGROUND

### 1. Technical Field

The present disclosure relates to an electrical connector for a circuit board, disposed on the mounting surface of a circuit board, to which a counterpart connector is fitted and connected.

### 2. Related Art

JP-A-2019-192347 discloses a socket connector, disposed on the mounting surface of a circuit board, to which a plug connector as a counterpart connector is fitted and connected. In this socket connector, a first socket terminal and a second socket terminal are suspended across a fixed housing and a movable housing. The movable housing is relatively movable with respect to the fixed housing due to the elastic displacement of the first socket terminal and the second socket terminal.

The first socket terminal and the second socket terminal have a shape in which a metal plate member is bent in a plate thickness direction, and are disposed so as to overlap each other in the plate thickness direction. Specifically, the first socket terminal is disposed such that the first socket terminal overlaps the second socket terminal from above. The first socket terminal includes a first fixed-side attachment portion press-fitted and held in the fixed housing, a first movable-side attachment portion press-fitted and held in the movable housing, a leg portion extending downward from the first fixed-side attachment portion and connectable to the circuit board, a first terminal portion extending upward from the first movable-side attachment portion and contactable to the plug connector, and a first elastic portion that is elastically displaceable and couples the first fixed-side attachment portion to the first movable-side attachment portion.

The first fixed-side attachment portion and the first movable-side attachment portion have a plate shape that extends across the entire range of the first socket terminal in the terminal width direction. The leg portion, the first terminal portion, and the first elastic portion are formed as thin strips extending in the long direction of the first socket terminal, and pluralities of the leg portions, the first terminal portions, and the first elastic portions are arranged in the terminal width direction.

The second socket terminal has substantially the same shape as the first socket terminal, and includes a second fixed-side attachment portion, a second movable-side attachment portion, a leg portion, a second terminal portion, and a second elastic portion. The second terminal portion is provided at a position displaced from the first terminal portion in the terminal width direction. Therefore, in a state where the first socket terminal and the second socket terminal overlap each other, the first terminal portion and the second terminal portion are alternately disposed in the terminal arrangement direction.

### SUMMARY

An electrical connector for a circuit board according to the present disclosure is an electrical connector for a circuit board, disposed on a mounting surface of the circuit board, to which a counterpart connector is fitted and connected, the electrical connector including: a plurality of terminals having a shape in which a metal plate member is bent in a plate thickness direction and disposed in an attitude in which a plate thickness surface is perpendicular to the mounting surface; and a housing that holds the plurality of terminals, in which the housing includes a fixed housing fixed to the circuit board via the terminal, and a movable housing relatively movable with respect to the fixed housing, in which the plurality of terminals includes a first terminal and a second terminal disposed so as to overlap the first terminal in the plate thickness direction, the first terminal includes a first connection portion formed on one end side and connectable to a circuit portion of the circuit board, a first arm portion formed on another end side and contactable with the counterpart connector, and a first intermediate portion located between the first connection portion and the first arm portion, the first intermediate portion includes a first fixed-side plate portion located on a fixed housing side, a first movable-side plate portion located on a movable housing side and held by the movable housing, and a first elastic portion that is elastically displaceable and couples the first fixed-side plate portion to the first movable-side plate portion, the second terminal includes a second connection portion formed on one end side and connectable to the circuit portion of the circuit board, a second arm portion formed on another end side and contactable to the counterpart connector, and a second intermediate portion located between the second connection portion and the second arm portion and extending along the first intermediate portion, the second intermediate portion includes a second fixed-side plate portion located on the fixed housing side, a second movable-side plate portion located on the movable housing side and held by the movable housing, and a second elastic portion that is elastically displaceable and connects the second fixed-side plate portion to the second movable-side plate portion, and one of the first fixed-side plate portion and the second fixed-side plate portion is held by the fixed housing, and the other is not held by the fixed housing.

### BRIEF DESCRIPTION OF DRAWINGS

FIG. 1 is a perspective view showing an electrical connector according to an embodiment together with a counterpart connector, showing a state immediately before the electrical connector and the counterpart connector are fitted and connected to each other;

FIG. 2 is a perspective view showing the members of the electrical connector in a separated manner;

FIG. 3 is a perspective view of the electrical connector, in which a fixed housing and a movable housing are partially omitted;

FIG. 4 is a cross-sectional view of the electrical connector taken along a plane perpendicular to the terminal arrangement direction, showing a cross section at the position of the terminal;

FIG. 5A is a cross-sectional view of a part of the electrical connector in a plane perpendicular to the connector width direction, showing a cross section at the position of a first fixed-side plate portion of a first terminal;

FIG. 5B is a cross-sectional view of a part of the electrical connector in a plane perpendicular to the connector width direction, showing a cross section at the position of a second fixed-side plate portion of a second terminal;

FIG. 6A shows cross-sectional views of a part of the electrical connector on a plane perpendicular to a connector fitting direction, showing cross sections at positions of a movable-side plate portion and the fixed-side plate portion of the terminal;

FIG. 6B is a cross-sectional view of a part of the electrical connector on the plane perpendicular to the connector fitting direction, showing a part of FIG. 6A in an enlarged manner;

FIG. 7A is a perspective view of the first terminal alone, showing a state viewed from one end side in the connector width direction;

FIG. 7B is a perspective view of the first terminal alone, showing a state viewed from the other end side in the connector width direction;

FIG. 8A is a perspective view of the second terminal alone, showing a state viewed from one end side in the connector width direction;

FIG. 8B is a perspective view of the second terminal alone, showing a state viewed from the other end side in the connector width direction;

FIG. 9A is a perspective view of the terminal, showing a state viewed from one end side in the connector width direction;

FIG. 9B is a perspective view of the terminal, showing a state viewed from the other end side in the connector width direction;

FIG. 10 is a side view of terminals facing each other in the connector width direction;

FIG. 11A is a front view of the terminal;

FIG. 11B is a rear view of the terminal;

FIG. 11C is a plan view of the terminal;

FIG. 12 is a cross-sectional view of the electrical connector and the counterpart connector on a plane perpendicular to the terminal arrangement direction, showing a cross section at the position of the terminal;

FIG. 13A is a perspective view of a first terminal alone, according to an exemplary modification;

FIG. 13B is a perspective view of a second terminal alone, according to the exemplary modification;

FIG. 14A is a cross-sectional view of a part of the electrical connector in a plane perpendicular to the connector width direction in the exemplary modification, showing a cross section at the position of a first fixed-side plate portion of a first terminal; and

FIG. 14B is a cross-sectional view of a part of the electrical connector in the plane perpendicular to the connector width direction in the exemplary modification, showing a cross section at the position of a second fixed-side plate portion of a second terminal.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

It is an object to provide an electrical connector for a circuit board capable of securing a large floating amount of a movable housing while avoiding an increase in the size of the connector.

1. An electrical connector for a circuit board according to the present disclosure is an electrical connector for a circuit board, disposed on a mounting surface of the circuit board, to which a counterpart connector is fitted and connected, the electrical connector including: a plurality of terminals having a shape in which a metal plate member is bent in a plate thickness direction and disposed in an attitude in which a plate thickness surface is perpendicular to the mounting surface; and a housing that holds the plurality of terminals, in which the housing includes a fixed housing fixed to the circuit board via the terminal, and a movable housing relatively movable with respect to the fixed housing.

In this electrical connector for a circuit board, the plurality of terminals includes a first terminal and a second terminal disposed so as to overlap the first terminal in the plate thickness direction, the first terminal includes a first connection portion formed on one end side and connectable to a circuit portion of the circuit board, a first arm portion formed on another end side and contactable with the counterpart connector, and a first intermediate portion located between the first connection portion and the first arm portion, the first intermediate portion includes a first fixed-side plate portion located on a fixed housing side, a first movable-side plate portion located on a movable housing side and held by the movable housing, and a first elastic portion that is elastically displaceable and couples the first fixed-side plate portion to the first movable-side plate portion, the second terminal includes a second connection portion formed on one end side and connectable to the circuit portion of the circuit board, a second arm portion formed on another end side and contactable to the counterpart connector, and a second intermediate portion located between the second connection portion and the second arm portion and extending along the first intermediate portion, the second intermediate portion includes a second fixed-side plate portion located on the fixed housing side, a second movable-side plate portion located on the movable housing side and held by the movable housing, and a second elastic portion that is elastically displaceable and connects the second fixed-side plate portion to the second movable-side plate portion, and one of the first fixed-side plate portion and the second fixed-side plate portion is held by the fixed housing, and the other is not held by the fixed housing.

In this electrical connector for a circuit board, one of the first fixed-side plate portion of the first terminal and the second fixed-side plate portion of the second terminal is held by the fixed housing, and the other is not held by the fixed housing. In the case in which the first fixed-side plate portion is not held by the fixed housing, the first fixed-side plate portion is allowed to be formed as a portion elastically displaceable together with the first elastic portion in the first terminal. Therefore, as compared with the case in which the first fixed-side plate portion is held by the fixed housing, it is possible to increase a so-called spring length, which is the length of the portion of the first terminal that is elastically displaceable. At this time, since it is unnecessary to increase the length of the entire first terminal, it is possible to avoid an increase in the size of the first terminal and the connector.

On the other hand, in the case in which the second fixed-side plate portion is not held by the fixed housing, the second fixed-side plate portion is allowed to be formed as a portion elastically displaceable together with the second elastic portion in the second terminal. Therefore, it is possible to increase the spring length of the second terminal, as compared with the case in which the second fixed-side plate portion is held by the fixed housing. At this time, since it is unnecessary to increase the length of the entire second terminal, it is possible to avoid an increase in the size of the second terminal and the connector.

By increasing the spring length of one of the first terminal and the second terminal without increasing the size of the connector in this manner, it is possible to secure a large floating amount of the movable housing.

2. In the aspect of (1), at least one of the first elastic portion and the second elastic portion may have a plurality of strips arranged in a terminal width direction perpendicular to the plate thickness direction. With such a configuration, the elastic portion (the first elastic portion or the second elastic portion) provided with the plurality of strips is elastically displaced at the individual strips having a small terminal width, and this enables easy elastic displacement, as compared with the case in which the plurality of strips is not provided. Therefore, it is possible to secure a much larger moving amount of the movable housing, i.e., a floating amount.

3. In the aspect of (1) or (2), such a configuration may be provided, in which the first terminal and the second terminal are press-fitted and held in the housing from the mounting surface side in a connector height direction perpendicular to the mounting surface, the first elastic portion is located on a side opposite to the mounting surface with respect to the second elastic portion in the connector height direction, the first connection portion and the second connection portion have a plate surface extending along the mounting surface of the circuit board, and are adjacent to each other in the terminal width direction, the first connection portion includes an abutment piece portion extending toward the second connection portion in the terminal width direction, and the abutment piece portion is located on a side opposite to the mounting surface in the connector height direction with respect to the second connection portion, and is allowed to abut on the second connection portion from the opposite side.

In such a configuration, the first elastic portion of the first terminal is located on the side opposite to the mounting surface with respect to the second elastic portion in the connector height direction. Therefore, at the time of assembling the connector, when the terminal is attached to the housing, the first terminal is press-fitted and attached to the housing prior to the second terminal in order to avoid interference with the second terminal, and then the second terminal is press-fitted and attached to the housing. By providing the abutment piece portion on the first connection portion of the first terminal attached to the housing first, when the second terminal is then attached to the housing, the abutment piece portion abuts on the second connection portion, and thus, it is possible to position the first connection portion or the second connection portion in the connector height direction.

Specifically, in the case in which the first fixed-side plate portion of the first terminal is not held by the fixed housing, when the second terminal is attached to the housing and the second fixed-side plate portion is held by the fixed housing, the second connection portion abuts on and supports the abutment piece portion from the mounting surface side in the connector height direction, and thus, the first connection portion is excellently positioned in the connector height direction.

On the other hand, in the case in which the first fixed-side plate portion of the first terminal is held by the fixed housing, when the second terminal is attached to the housing, the abutment piece portion abuts on and supports the second connection portion from the side opposite to the mounting surface in the connector height direction, and thus, an excessive movement of the second connection portion toward the opposite side is restricted. Therefore, the second connection portion is excellently positioned in the connector height direction.

### ADVANTAGEOUS EFFECTS OF THE INVENTION

It is possible to provide an electrical connector for a circuit board capable of securing a large floating amount of a movable housing while avoiding an increase in the size of the connector.

In the following, an embodiment of the present disclosure will be described with reference to the accompanying drawings.

In the present embodiment, an electrical connector 1 (in the following, referred to as "the connector 1") and a counterpart connector 2, which is fitted and connected to the connector 1, constitute an electrical connector assembly. The connector 1 and the counterpart connector 2 are an electrical connector for a circuit board mounted on different circuit boards (not shown). In the present embodiment, the connector 1 and the counterpart connector 2 are used for the transmission of power supply signals.

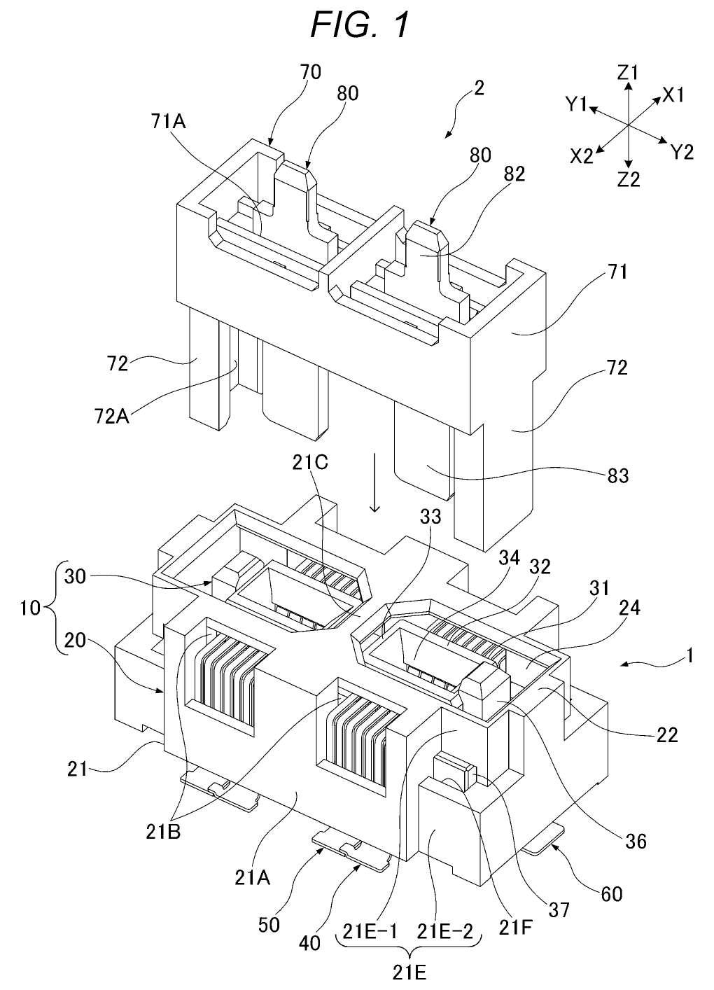

The connector 1 is disposed on the mounting surface of a circuit board (not shown), in which the mounting surface is perpendicular to a vertical direction (Z-axis direction), which is a connector height direction. The counterpart connector 2 is disposed on the mounting surface of another circuit board (not shown), in which the mounting surface is perpendicular to the vertical direction. Both the connectors 1 and 2 are fitted and connected to each other with the vertical direction as a connector fitting direction in an attitude in which the mounting surfaces of the circuit board and the other circuit board face each other in the vertical direction. Specifically, as indicated by an arrow in FIG. 1, the counterpart connector 2 is fitted and connected to the connector 1 from above. That is, in the connector 1, the upper side (Z1 side) is a fitting side to the counterpart connector 2. In the counterpart connector 2, the lower side (Z2 side) is a fitting side (counterpart fitting side) to the connector 1.

The connector 1 includes a housing 10 extending in one direction (Y-axis direction) parallel to the mounting surface of the circuit board as a long direction, pluralities of metal plate terminals 40 and 50 arranged and held in the housing 10 with the long direction as a terminal arrangement direction, and two fixing brackets 60 held in the housing 10.

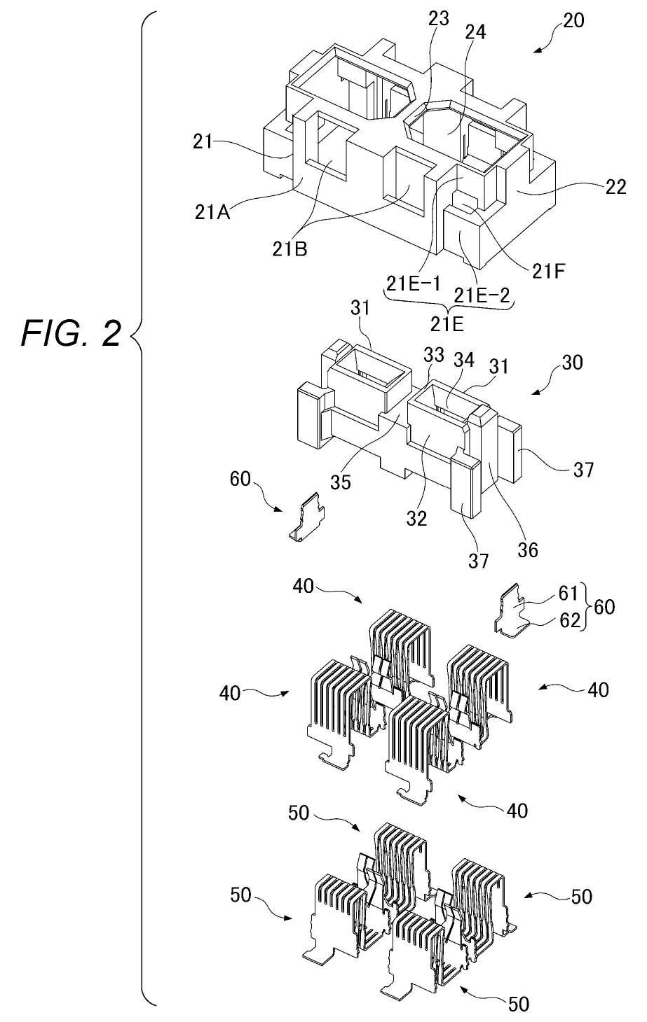

The terminals 40 and 50 are power supply terminals used for the transmission of power supply signals, and include a first terminal 40 and a second terminal 50 having different shapes. In the case in which it is unnecessary to distinguish between the first terminal 40 and the second terminal 50, the terminals are collectively referred to as "the terminals 40 and 50" for convenience of description. As shown in FIGS. 2 to 4, the terminals 40 and 50 are disposed in a state where one first terminal 40 and one second terminal 50 overlap each other in a plate thickness direction to form a pair (in the following, referred to as "a terminal pair") in an attitude in which a plate thickness surface is perpendicular to the mounting surface (not shown) of the circuit board. Two terminal pairs are arranged in the terminal arrangement direction (Y-axis direction) to form two terminal rows facing each other in a connector width direction (X-axis direction). That is, four terminal pairs are provided in the connector 1.

The housing 10 is made of an electrical insulating material such as a resin, and includes a fixed housing 20 attached to the circuit board via the terminals 40 and 50, and a movable housing 30 that is a separate member from the fixed housing 20 and is relatively movable with respect to the fixed housing 20. The terminals 40 and 50 are suspended across the fixed housing 20 and the movable housing 30, and the elastic displacement of the terminals 40 and 50 allows for the relative movement (floating) of the movable housing 30 with respect to the fixed housing 20.

The fixed housing 20 has a substantially rectangular parallelepiped outer shape that extends in the terminal arrangement direction, which is a long direction, and has a rectangular frame-shaped peripheral wall with an internal space 24 that penetrates in the vertical direction. As shown in FIGS. 1 to 3, the peripheral wall of the fixed housing 20 has two fixed-side sidewalls 21 extending in the terminal arrangement direction and two fixed-side end walls 22 extending in the connector width direction and coupling the end portions of the fixed-side sidewalls 21 to each other. The upper end portions of the two fixed-side sidewalls 21 are coupled to each other with a coupling portion 23 extending in the connector width direction at a middle position in the terminal arrangement direction. Therefore, when the fixed housing 20 is viewed from above, the internal space 24 is partitioned into two with the coupling portion 23.

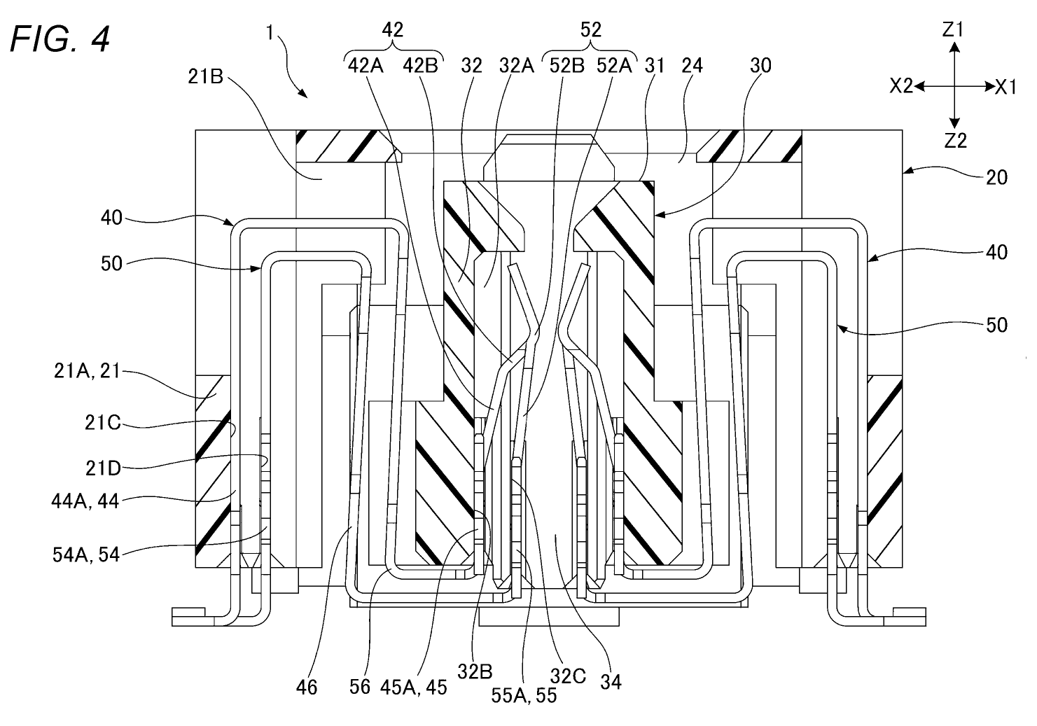

As shown in FIGS. 1 and 2, the fixed-side sidewall 21 includes an intermediate wall 21A extending across the terminal arrangement range and restricting portions 21E located on both outer sides of the intermediate wall 21A. In the intermediate wall 21A, two fixed-side recesses 21B are formed to be arranged in the terminal arrangement direction. As shown in FIG. 4, the fixed-side recess 21B is recessed from an inner surface (a surface perpendicular to the connector width direction) and extends in the vertical direction, and houses a part of the first terminal 40 (a part of a first elastic portion 46 and a first fixed-side plate portion 44, described later) and a part of the second terminal 50 (a part of a second elastic portion 56 and a second fixed-side plate portion 54, described later). The upper portion of the fixed-side recess 21B penetrates the intermediate wall 21A, and its lower end is open.

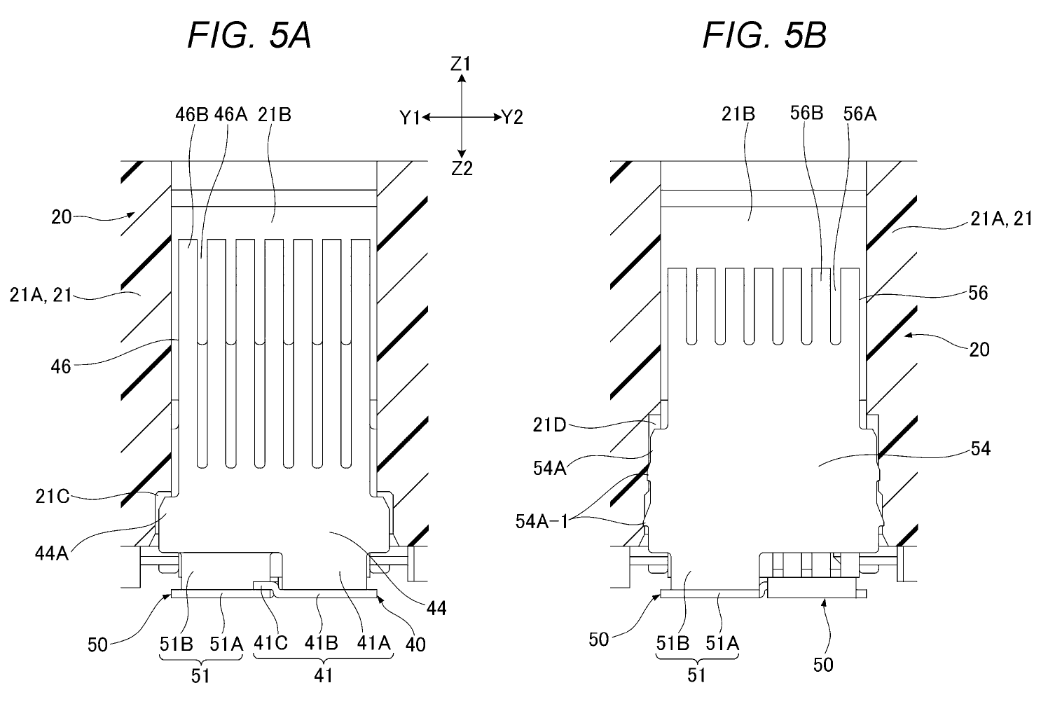

As shown in FIGS. 4, 5A, and 5B, in the fixed-side recess 21B, a first fixed-side groove 21C and a second fixed-side groove 21D forming a part of the fixed-side recess 21B are formed on both sides in the terminal arrangement direction. The first fixed-side groove 21C houses a part of the first terminal 40 (an edge portion 44A, described later). The second fixed-side groove 21D is formed inside the first fixed-side groove 21C in the connector width direction, and houses a part of the second terminal 50 (a second fixed-side held portion 54A, described later). In FIG. 5B, the illustration of the first terminal 40 shown in FIG. 5A is omitted.

In the following, in the case in which it is unnecessary to distinguish between the first fixed-side groove 21C and the second fixed-side groove 21D, the first fixed-side groove and the second fixed-side groove are collectively referred to as "the fixed-side groove parts 21C and 21D" for convenience of description. The fixed-side grooves 21C and 21D have a groove shape that is recessed from the inner surface (a surface perpendicular to the terminal arrangement direction) of the lower part of the fixed-side recess 21B and extends in the vertical direction. As shown in FIGS. 5A and 5B, the upper ends of the fixed-side grooves 21C and 21D are closed, and the lower ends are open. The second fixed-side groove 21D is formed to be longer in the vertical direction than the first fixed-side groove 21C, and the upper end is located above the upper end of the first fixed-side groove 21C.

As shown in FIG. 5A, the first fixed-side groove 21C houses the edge portion 44A of the first terminal 40 without holding the edge portion 44A in a state where a gap is formed between the first fixed-side groove and the edge portion 44A. On the other hand, as shown in FIG. 5B, the second fixed-side groove 21D houses the second fixed-side held portion 54A of the second terminal 50 in a press-fitted state. That is, the second fixed-side groove 21D functions as a fixed-side holding portion that holds the second fixed-side held portion 54A.

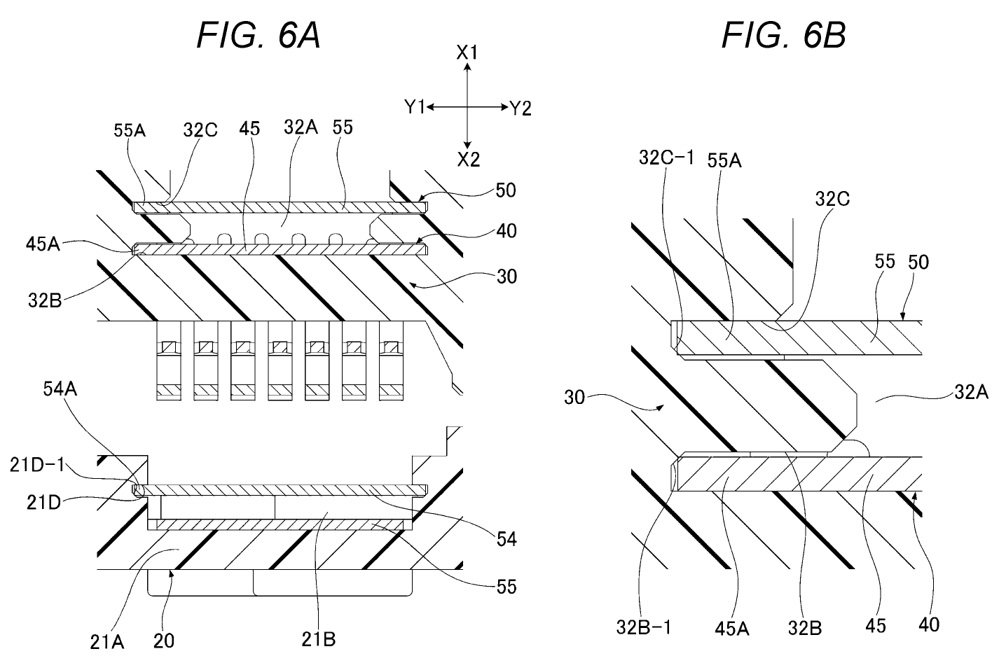

As shown in FIG. 6A, in the second fixed-side groove 21D, the inner surface of the outer corner in the connector width direction is formed as an inclined surface 21D-1 that is inclined outward in the terminal arrangement direction (Y-axis direction) as the inner surface goes inward (X1 direction in FIG. 6A) in the connector width direction (X-axis direction). Therefore, a force of a component directed inward in the connector width direction acts on the corner portion of the second fixed-side held portion 54A abutting on the inclined surface 21D-1. As a result, the second fixed-side held portion 54A is pressed against the inner surface (the surface on the X1 side in FIG. 6A) of the second fixed-side groove 21D on the inner side in the connector width direction. Therefore, the second fixed-side held portion 54A is supported by the inner surface, and thus, it is possible to stabilize the attitude of the second fixed-side plate portion 54.

As shown in FIGS. 1 and 2, in the restricting portion 21E, the upper portion 21E-1 is located inside the lower portion 21E-2 in the connector width direction, and a boundary portion between the upper portion 21E-1 and the lower portion 21E-2 has a stepped shape. The restricting portion 21E is formed with a restricting recess 21F recessed from the inner surface of the restricting portion 21E, and a part of the movable housing 30 (a restricted portion 37, described later) is housed in the restricting recess 21F. The restricting recess 21F is formed in a range from the intermediate position of the upper portion 21E-1 to the lower end of the lower portion 21E-2 in the vertical direction. The restricting recess 21F is formed in a range extending across the upper portion 21E-1 and the lower portion 21E-2 in the connector width direction, and penetrates the restricting portion 21E at the boundary portion. The inner surface of the restricting recess 21F restricts the movement of the movable housing 30 by a predetermined amount or more.

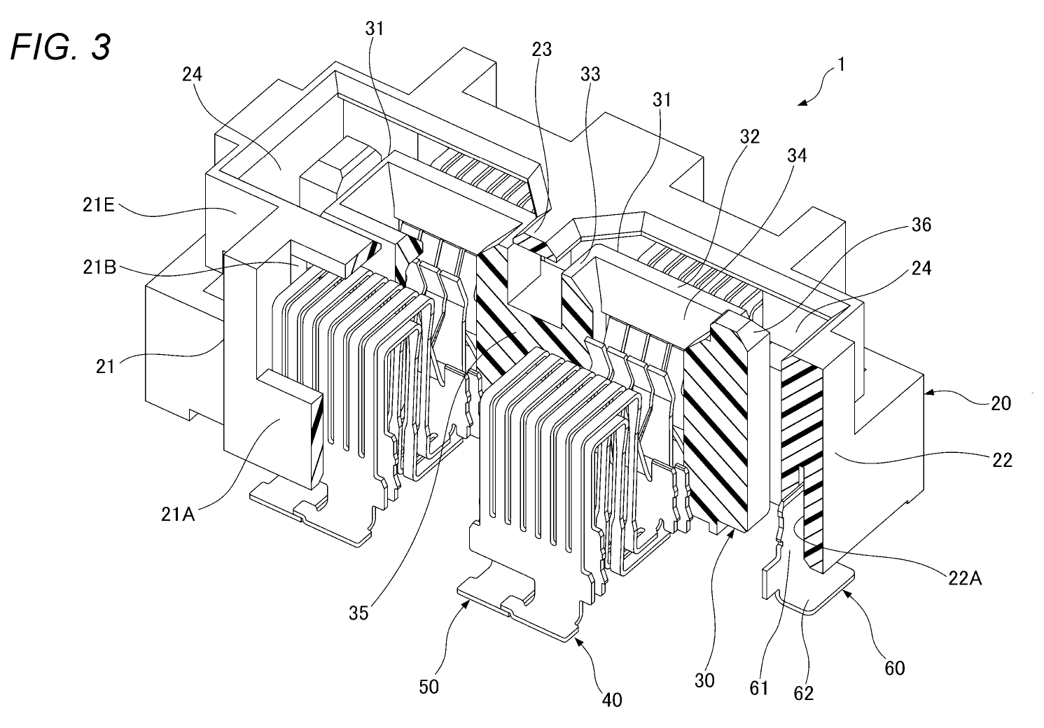

As shown in FIG. 3, the fixed-side end wall 22 has a bracket holding portion 22A that holds the fixing bracket 60 at the lower portion. The bracket holding portion 22A is formed in a groove shape that extends in the vertical direction at a middle position in the connector width direction, and press-fits and holds the fixing bracket 60.

As shown in FIGS. 1 and 2, the movable housing 30 includes two fitting portions 31 that fit to the counterpart connector 2, a central wall 35 located between the two fitting portions 31, and a guide portion 36 and a restricted portion 37 coupled to the end portion of the fitting portion 31. The movable housing 30 is housed in the internal space 24 of the fixed housing 20.

The two fitting portions 31 are arranged in the terminal arrangement direction. The fitting portion 31 has a quadrangular tubular shape that extends in the vertical direction, and includes two movable-side sidewalls 32 extending in the terminal arrangement direction and two movable-side end walls 33 extending in the connector width direction, which couples the end portions of the movable-side sidewalls 32 to each other. The internal space of the fitting portion 31, i.e., the space surrounded by the movable-side sidewall 32 and the movable-side end wall 33 and penetrating in the vertical direction, is formed as a receiving portion 34 that receives a part of the counterpart connector 2.

As shown in FIG. 4, the movable-side sidewall 32 is formed with a movable-side recess 32A that is recessed from an inner surface (a surface perpendicular to the connector width direction) and extends in the vertical direction. The movable-side recess 32A has a closed upper end and an open lower end. The movable-side recess 32A houses a part of the first terminal 40 (a first arm portion 42 and a first movable-side plate portion 45, described later) and a part of the second terminal 50 (a second arm portion 52 and a second movable-side plate portion 55, described later). As shown in FIGS. 4, 6A, and 6B, in the movable-side recess 32A, a first movable-side groove 32B and a second movable-side groove 32C forming a part of the movable-side recess 32A are formed on both sides in the terminal arrangement direction. The first movable-side groove 32B houses a part of the first terminal 40 (a first movable-side held portion 45A, described later). The second movable-side groove 32C is formed inside the first movable-side groove 32B in the connector width direction, and houses a part of the second terminal 50 (a second movable-side held portion 55A, described later).

In the following, in the case in which it is unnecessary to distinguish between the first movable-side groove 32B and the second movable-side groove 32C, the first movable-side groove and the second movable-side groove are collectively referred to as "the fixed-side grooves 32B and 32C" for convenience of description. The fixed-side grooves 32B and 32C have a groove shape that is recessed from the inner surface (a surface perpendicular to the terminal arrangement direction) of the lower part of the movable-side recess 32A and extends in the vertical direction. The upper ends of the fixed-side grooves 32B and 32C are closed, and the lower ends are opened.

As shown in FIGS. 6A and 6B, the first movable-side groove 32B houses the first movable-side held portion 45A of the first terminal 40 in a press-fitted state. That is, the first movable-side groove 32B functions as a first movable-side holding portion that holds the first movable-side held portion 45A. As shown in FIGS. 6A and 6B, the second movable-side groove 32C houses the second movable-side held portion 55A of the second terminal 50 in a press-fitted state. That is, the second movable-side groove 32C functions as a second movable-side holding portion that holds the second movable-side held portion 55A.

As shown in FIG. 6B, in the first movable-side groove 32B, the inner surface of the corner on the inner side in the connector width direction (X1 side in FIG. 6B) is formed as an inclined surface 32B-1 inclined inward in the terminal arrangement direction as the inner surface goes inward in the connector width direction. Therefore, the force of a component directed outward (X2 side in FIG. 6B) in the connector width direction acts on the corner portion of the first movable-side held portion 45A abutting on the inclined surface 32B-1. As a result, the first movable-side plate portion 45 is pressed against the inner surfaces of the movable-side recess 32A and the first movable-side groove 32B on the outer side (X2 side in FIG. 6B) in the connector width direction. Therefore, since the first movable-side plate portion 45 is supported by the inner surfaces, the attitude of the first movable-side plate portion 45 can be stabilized. In the present embodiment, as shown in FIGS. 6A and 6B, the wall portion located on the outer side in the connector width direction, with respect to the first movable-side plate portion 45, is thicker than the wall portion located on the inner side. As described above, since the first movable-side plate portion 45 is pressed against the thicker wall, it is possible to reduce the load applied to the movable housing 30.

As shown in FIG. 6B, in the second movable-side groove 32C, the inner surface of the corner on the outer side in the connector width direction (X2 side in FIG. 6B) is formed as an inclined surface 32C-1 inclined inward in the terminal arrangement direction toward the outer side in the connector width direction. Therefore, the force of a component directed inward (X1 side in FIG. 6B) in the connector width direction acts on the corner portion of the second movable-side held portion 55A abutting on the inclined surface 32C-1. As a result, the second movable-side held portion 55A is pressed against the inner surface of the second movable-side groove 32C on the inner side (X1 side in FIG. 6B) in the connector width direction. Therefore, since the second movable-side held portion 55A is supported by the inner surface, the attitude of the second movable-side plate portion 55 can be stabilized. In the present embodiment, as shown in FIGS. 6A and 6B, the wall portion located on the inner side in the connector width direction, with respect to the second movable-side held portion 55A, is thicker than the wall portion located on the outer side. As described above, since the second movable-side held portion 55A is pressed against the thicker wall portion, it is possible to reduce the load applied to the movable housing 30.

As shown in FIGS. 2 and 3, the central wall 35 is located between the two fitting portions 31 and couples the movable-side end walls 33 to each other on the inner sides in the terminal arrangement direction. As shown in FIGS. 1 to 3, the guide portion 36 is coupled to the outer surface of the movable-side end wall 33 located outside in the terminal arrangement direction and has a substantially quadrangular prism shape that extends in the vertical direction. The upper end portion of the guide portion 36 has a tapered shape and is located above the fitting portion 31. The guide portion 36 guides the counterpart connector 2 to a normal fitting position in the connector fitting process.

As shown in FIG. 2, the restricted portion 37 is located on both sides of the guide portion 36 in the connector width direction and is provided, being coupled to the corner of the fitting portion 31. The restricted portion 37 has a substantially quadrangular prism shape that extends in the vertical direction, and is partially displaced downward with respect to the fitting portion 31. As shown in FIG. 1, the restricted portion 37 is housed in the restricting recess 21F, and is restricted from moving upward, outward in the terminal arrangement direction, and outward in the connector width direction by a predetermined amount or more by the inner surface of the restricting recess 21F.

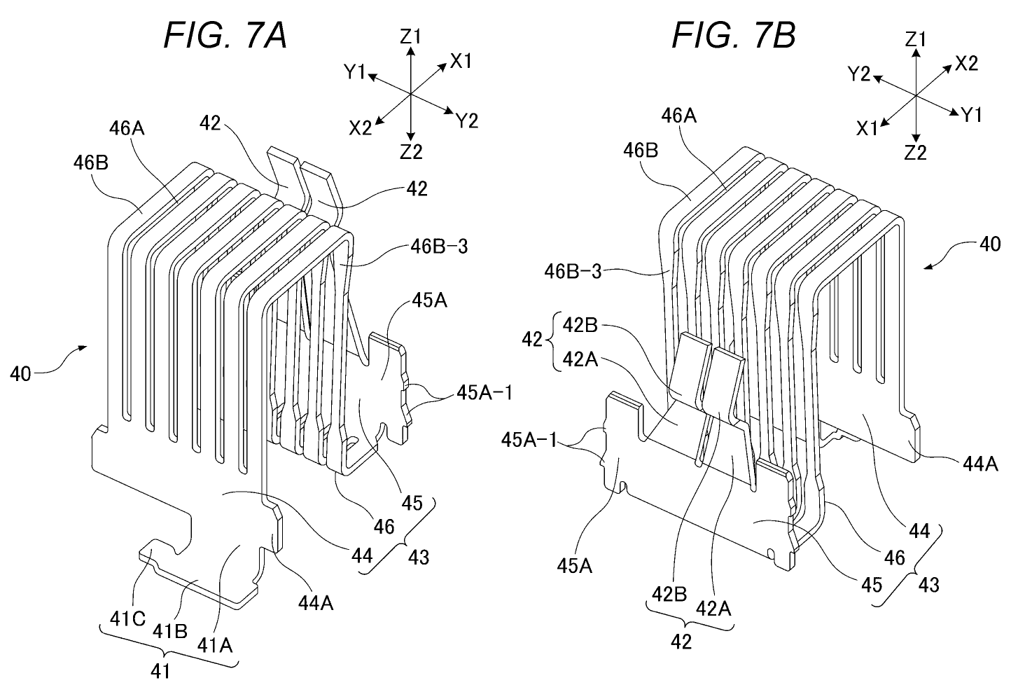

The first terminal 40 is formed by bending a metal plate member in the plate thickness direction, and is disposed in an attitude in which the terminal arrangement direction (Y-axis direction) is the terminal width direction (direction perpendicular to the plate thickness direction). FIGS. 7A and 7B are perspective views of the first terminal 40 alone, provided in the X2-side terminal row. As shown in FIGS. 7A and 7B, the first terminal 40 includes a first leg portion 41 formed on one end side, two first arm portions 42 formed on the other end side, and a first intermediate portion 43 located between the first leg portion 41 and the first arm portion 42. The first intermediate portion 43 includes the first fixed-side plate portion 44 housed in the fixed housing 20, the first movable-side plate portion 45 housed and held in the movable housing 30, and the first elastic portion 46 elastically displaceable and coupling the first fixed-side plate portion 44 and the first movable-side plate portion 45.

As shown in FIG. 7A, the first leg portion 41 extends from the lower end of a Y2-side portion of the first fixed-side plate portion 44. The first leg portion 41 includes a first extension portion 41A extending downward from the lower end of the first fixed-side plate portion 44, a first connection portion 41B bent at the lower end of the first extension portion 41A and extending outward in the connector width direction, and an abutment piece portion 41C extending from the first connection portion 41B in the terminal width direction. The first connection portion 41B is disposed on the circuit portion of the mounting surface of the circuit board and solder-connected to the circuit portion.

The abutment piece portion 41C extends from the side edge of the first connection portion 41B on the Y1 side. As shown in FIG. 5A, the abutment piece portion 41C is bent in a crank shape from the side edge of the first connection portion 41B and extends toward the Y1 side, and is located above the first connection portion 41B by the plate thickness dimension of the terminals 40 and 50. When the first terminal 40 and the second terminal 50 are disposed so as to overlap each other, as shown in FIG. 5A, the lower surface of the abutment piece portion 41C comes into contact with the upper surface of a second connection portion 51B, described later, of the second terminal 50 from above (the side opposite to the mounting surface of the circuit board in the vertical direction).

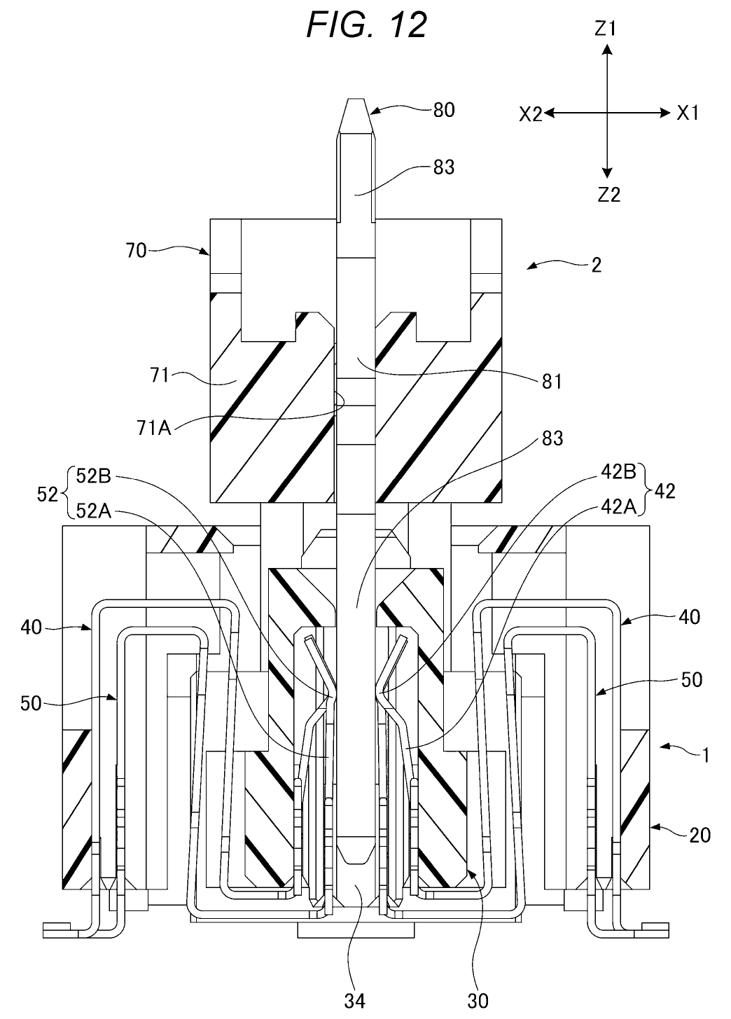

The two first arm portions 42 are provided adjacent to each other in the terminal width direction. As shown in FIG. 7B, the first arm portion 42 has a first extending portion 42A extending upward from the upper end of the first movable-side plate portion 45, i.e., toward the other end side of the first terminal 40, and a first contact portion 42B located above the first extending portion 42A. As shown in FIG. 4, the first extending portion 42A extends so as to be inclined inward in the connector width direction. As a result, the first contact portion 42B protrudes from the movable-side recess 32A and is located in the receiving portion 34. The first arm portion 42 is elastically displaceable in the plate thickness direction (X-axis direction), and comes into contact with a counterpart terminal 80, described later, provided in the counterpart connector 2 at the first contact portion 42B (see FIG. 12).

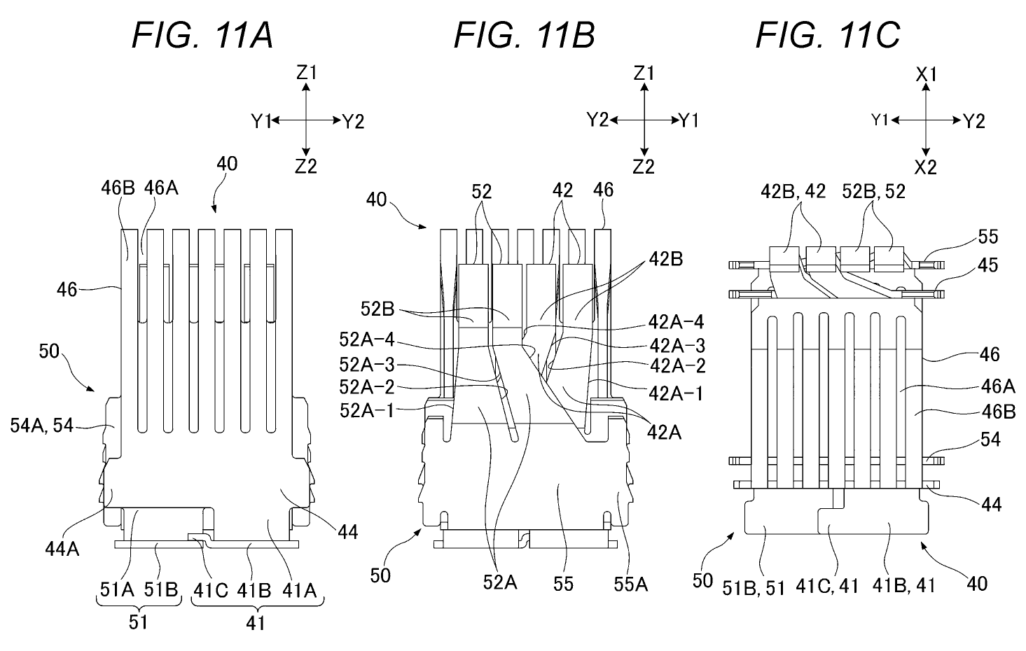

The first extending portion 42A extends such that the terminal width dimension (width dimension in the Y-axis direction) decreases continuously toward the upper side. Both side edges of the first extending portion 42A extend inclinedly toward the Y1 side in the terminal width direction toward the upper side. Specifically, as shown in FIG. 11B, in the first extending portion 42A located on the Y1 side of the two first extending portions 42A, a side edge 42A-2 on the Y2 side is inclined at an angle larger than that of a side edge 42A-1 on the Y1 side. In the first extending portion 42A located on the Y2 side, a side edge 42A-3 on the Y1 side is inclined at the same angle as the side edge 42A-2, and a side edge 42A-4 on the Y2 side is inclined at an angle larger than the side edge 42A-3 on the Y1 side. Therefore, the two first contact portions 42B are provided adjacent to each other at positions close to the Y1 side in the terminal width direction.

In this manner, the first extending portion 42A extends upward while reducing its terminal width dimension. In other words, the first extending portion 42A is formed such that the lower-end-side portion (base side portion) is larger than the upper-end-side portion in the terminal width direction, i.e., the first extending portion is wider. By widening the width of the lower-end-side portion of the first extending portion 42A in this manner, the cross-sectional area of the lower-end-side portion can be increased, and thus, it is possible to flow a larger current using the first terminal 40 than before.

As shown in FIGS. 7A and 7B, the first fixed-side plate portion 44 has a plate shape that extends in the terminal width direction, which is a long direction, and is disposed in an attitude such that its plate surface is perpendicular to the connector width direction. The first fixed-side plate portion 44 has its terminal width dimension larger than that of the first elastic portion 46, and the edge portions 44A on both sides in the terminal width direction are located outside the first elastic portion 46. As shown in FIGS. 4 and 5A, the first fixed-side plate portion 44 is housed in the fixed-side recess 21B of the fixed housing 20. The edge portion 44A is housed in the first fixed-side groove 21C. At this time, the edge portion 44A is disposed in a state where a gap is formed between the edge portion 44A and the inner surface of the first fixed-side groove 21C, and is displaceable within the range of the gap.

As shown in FIGS. 7A and 7B, the first movable-side plate portion 45 has a plate shape that extends in the terminal width direction, which is a long direction, and is disposed in an attitude such that its plate surface is perpendicular to the connector width direction. The first movable-side plate portion 45 has its terminal width dimension larger than that of the first elastic portion 46, and the first movable-side held portion 45A formed at both edge portions in the terminal width direction is located outside the first elastic portion 46. As shown in FIGS. 4, 6A, and 6B, the first movable-side held portion 45A is housed in the movable-side recess 32A of the movable housing 30. The first movable-side held portion 45A is housed in the first movable-side groove 32B. At this time, the first movable-side held portion 45A is press-fitted and held in the first movable-side groove 32B by causing a plurality of press-fit protrusions 45A-1 (see FIGS. 7A and 7B), which protrudes outward in the terminal width direction, to bite into the inner surface of the first movable-side groove 32B.

As shown in FIGS. 7A and 7B, the first elastic portion 46 is bent in the plate thickness direction at a plurality of positions in the long direction of the first terminal 40, and couples the upper end of the first fixed-side plate portion 44 to the lower end of the first movable-side plate portion 45. The first elastic portion 46 is formed with a plurality of slits 46A extending in the long direction and penetrating in the plate thickness direction at a plurality of positions in the terminal width direction. The first elastic portion 46 is formed with a plurality of strips 46B that extends along the slits 46A. The first elastic portion 46 is elastically displaceable in the connector width direction, the terminal arrangement direction, and the vertical direction by the strip 46B. As described above, in the present embodiment, since the first elastic portion 46 is elastically displaced by the strip 46B having a small terminal width dimension, the first elastic portion is easily elastically displaced as compared with the case in which the strip is not provided. Therefore, it is possible to secure a much larger movement amount of the movable housing 30, i.e., a larger floating amount.

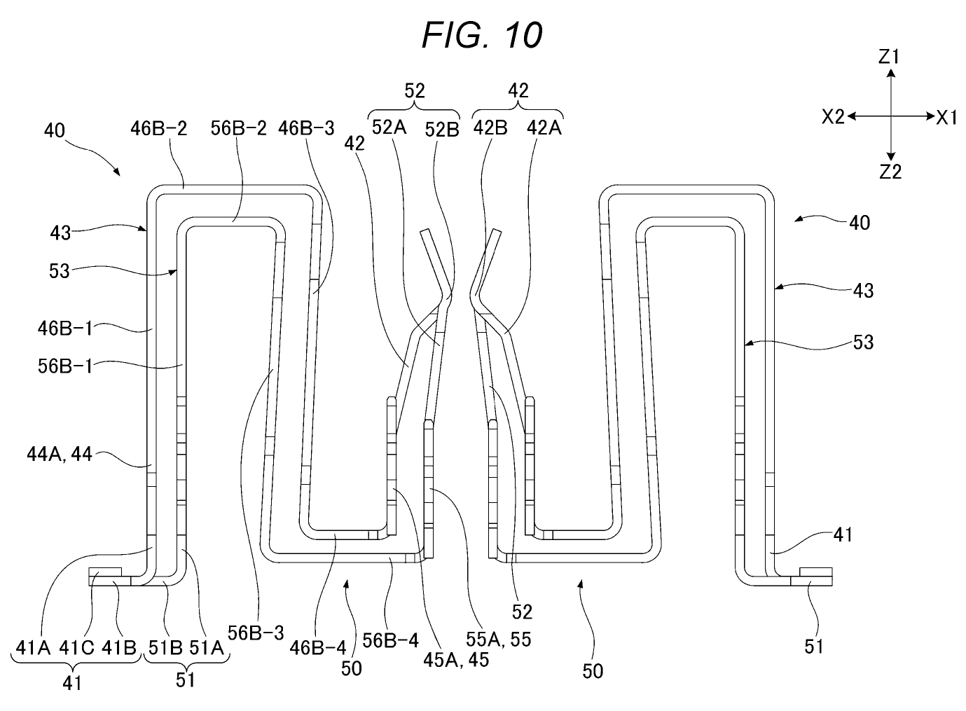

As shown in FIG. 10, the first elastic portion 46 includes an outer piece portion 46B-1 extending upward from the upper end of the first fixed-side plate portion 44, an upper piece portion 46B-2 bent at the upper end of the outer piece portion 46B-1 and extending inward in the connector width direction, an inner piece portion 46B-3 bent at the inner end (inner end in the connector width direction) of the upper piece portion 46B-2 and extending downward, and a lower piece portion 46B-4 bent at a lower end of the inner piece portion 46B-3 and extending inward in the connector width direction and coupled to the lower end of the first movable-side plate portion 45. As shown in FIGS. 7A and 7B, the inner piece portion 46B-3 is formed such that its terminal width dimension of the intermediate portion in the vertical direction is formed smaller than that of the other portion, i.e., formed narrowly. As described above, by narrowing the width of the intermediate portion of the inner piece portion 46B-3, the inner piece portion 46B-3 is more easily elastically displaced.

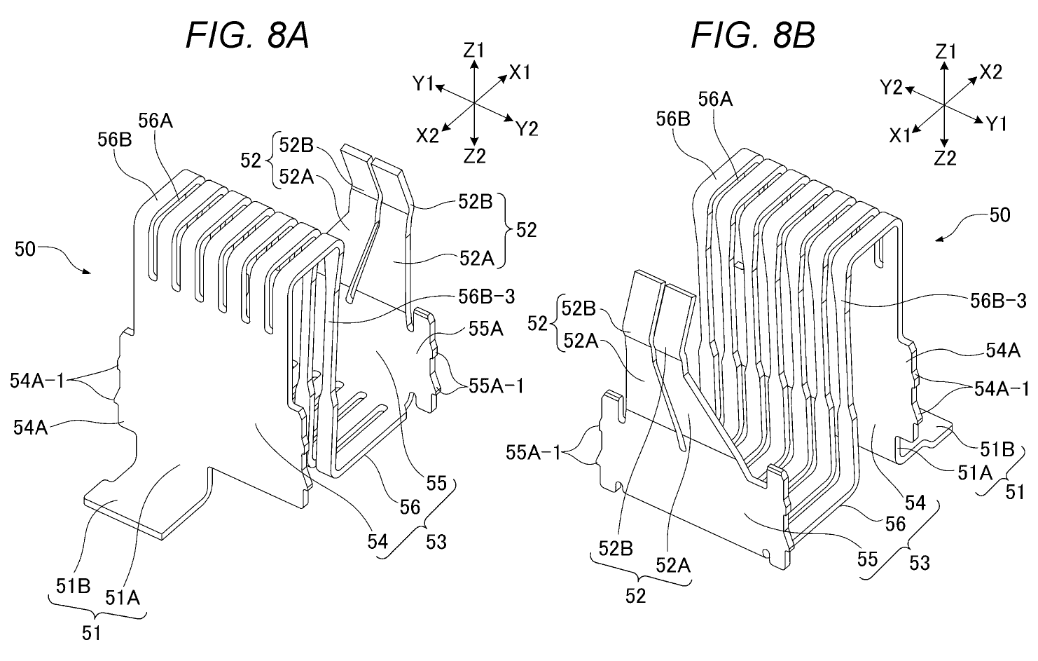

The second terminal 50 is formed by bending a metal plate member having the same plate thickness dimension and the same terminal width dimension as those of the first terminal 40 in the plate thickness direction, and is disposed in an attitude in which the terminal arrangement direction (Y-axis direction) is the terminal width direction (direction perpendicular to the plate thickness direction). FIGS. 8A and 8B are perspective views of the second terminal 50 alone, provided in the terminal row on the X2 side. As shown in FIGS. 8A and 8B, the second terminal 50 includes a second leg portion 51 formed on one end side, two second arm portions 52 formed on the other end side, and a second intermediate portion 53 located between the second leg portion 51 and the second arm portion 52. The second intermediate portion 53 includes a second fixed-side plate portion 54 housed and held in the fixed housing 20, a second movable-side plate portion 55 housed and held in the movable housing 30, and a second elastic portion 56 elastically displaceable and coupling the second fixed-side plate portion 54 and the second movable-side plate portion 55.

As shown in FIG. 8A, the second leg portion 51 extends from the lower end of the portion on the Y1 side of the second fixed-side plate portion 54. The second leg portion 51 includes a second extension portion 51A extending downward from the lower end of the second fixed-side plate portion 54, and a second connection portion 51B bent at the lower end of the second extension portion 51A and extending outward in the connector width direction. The second connection portion 51B is disposed on the circuit portion of the mounting surface of the circuit board and is solder-connected to the circuit portion.

The two second arm portions 52 are provided adjacent to each other in the terminal width direction. As shown in FIGS. 8A and 8B, the second arm portion 52 has a second extending portion 52A extending upward from the upper end of the second movable-side plate portion 55, i.e., toward the other end side of the second terminal 50, and a second contact portion 52B located above the second extending portion 52A. As shown in FIG. 4, the second extending portion 52A extends so as to be inclined inward in the connector width direction. As shown in FIG. 4, the inclination angle of the second extending portion 52A is smaller than the inclination angle of the first extending portion 42A. The second contact portion 52B protrudes from the movable-side recess 32A and is located in the receiving portion 34. The second arm portion 52 is elastically displaceable in the plate thickness direction (X-axis direction), and comes into contact with a counterpart terminal 80, described later, provided in the counterpart connector 2 at the second contact portion 52B (see FIG. 12).

The second extending portion 52A extends such that the terminal width dimension decreases continuously toward the upper side. Both side edges of the second extending portion 52A extend inclinedly toward the Y2 side in the terminal width direction toward the upper side. Specifically, as shown in FIG. 11B, in the second extending portion 52A located on the Y2 side of the two second extending portions 52A, the side edge 52A-2 on the Y1 side is inclined at an angle larger than that of the side edge 52A-1 on the Y1 side. In the second extending portion 52A located on the Y1 side, the side edge 52A-3 on the Y2 side is inclined at the same angle as the side edge 52A-2, and the side edge 52A-4 on the Y1 side is inclined at an angle larger than the side edge 52A-3 on the Y2 side. Therefore, the two second contact portions 52B are provided adjacent to each other at positions close to the Y2 side in the terminal width direction.

In this manner, the second extending portion 52A extends upward while reducing its terminal width dimension. In other words, in the second extending portion 52A, the lower-end-side portion (base side portion) is formed to be larger than the upper-end-side portion in the terminal width direction, i.e., formed widely. As described above, by widening the width of the lower-end-side portion of the second extending portion 52A, the cross-sectional area of the lower-end-side portion can be increased, and thus, it is possible to flow a larger current using the second terminal 50 than before.

As shown in FIGS. 8A and 8B, the second fixed-side plate portion 54 has a plate shape that extends in the terminal width direction, which is the long direction, and is disposed in an attitude such that the plate surface is perpendicular to the connector width direction. As shown in FIG. 4, the second fixed-side plate portion 54 is formed larger than the first fixed-side plate portion 44 in the vertical direction, and is located inside the first fixed-side plate portion 44 in the connector width direction. The second fixed-side plate portion 54 is formed larger than the first fixed-side plate portion 44 in the vertical direction. The second fixed-side plate portion 54 has its terminal width dimension larger than that of the second elastic portion 56, and the second fixed-side held portions 54A formed at the edge portions on both sides in the terminal width direction are located outside the second elastic portion 56.

As shown in FIGS. 4, 5B, and 6A, the second fixed-side plate portion 54 is housed in the fixed-side recess 21B of the fixed housing 20. The second fixed-side held portion 54A is housed in the second fixed-side groove 21D. At this time, the second fixed-side held portion 54A is press-fitted and held in the second fixed-side groove 21D by causing a plurality of press-fit protrusions 54A-1 (see FIGS. 8A and 8B), which protrudes outward in the terminal width direction, to bite into the inner surface of the second fixed-side groove 21D.

As shown in FIGS. 8A and 8B, the second movable-side plate portion 55 has a plate shape that extends in the terminal width direction, which is a long direction, and is disposed in an attitude such that its plate surface is perpendicular to the connector width direction. As shown in FIG. 4, the second movable-side plate portion 55 is formed to have substantially the same size as the first movable-side plate portion 45 in the vertical direction, and is located inside the first movable-side plate portion 45 in the connector width direction.

The second movable-side plate portion 55 has its terminal width dimension larger than that of the second elastic portion 56, and the second movable-side held portion 55A formed at both edge portions in the terminal width direction is located outside the second elastic portion 56. The second movable-side held portion 55A is housed in the movable-side recess 32A of the movable housing 30. The second movable-side held portion 55A is housed in the second movable-side groove 32C. At this time, the second movable-side held portion 55A is press-fitted and held in the second movable-side groove 32C by causing a plurality of press-fit protrusions 55A-1 (see FIGS. 8A and 8B), which protrudes outward in the terminal width direction, to bite the inner surface of the second movable-side groove 32C.

As shown in FIGS. 8A and 8B, the second elastic portion 56 is bent in the plate thickness direction at a plurality of positions in the long direction of the second terminal 50, and couples the upper end of the second fixed-side plate portion 54 to the lower end of the second movable-side plate portion 55. In the second elastic portion 56, a plurality of slits 56A having the same shape as the slit 46A extends in the long direction and penetrates in the plate thickness direction at a plurality of positions the same as the slit 46A of the first terminal 40 in the terminal width direction. In the second elastic portion 56, a plurality of strips 56B having the same shape as the strip 46B is formed to extend along the slits 56A at a plurality of positions, the same as the strip 46B of the first terminal 40 in the terminal width direction. The second elastic portion 56 is elastically displaceable in the connector width direction, the terminal arrangement direction, and the vertical direction by the strip 56B. As described above, in the present embodiment, since the second elastic portion 56 is elastically displaced by the strip 56B having a small terminal width dimension, the second elastic portion is easily elastically displaced as compared with the case in which the strip is not provided. Therefore, it is possible to secure a much larger movement amount of the movable housing 30, i.e., a larger floating amount.

As shown in FIG. 10, the second elastic portion 56 includes an outer piece portion 56B-1 extending upward from the upper end of the second fixed-side plate portion 54, an upper piece portion 56B-2 bent at the upper end of the outer piece portion 56B-1 and extending inward in the connector width direction, an inner piece portion 56B-2 bent at the inner end (an inner end in the connector width direction) of the upper piece portion 56B-3 and extending downward, and a lower piece portion 56B-3 bent at the lower end of the inner piece portion 56B-4 and extending inward in the connector width direction and coupled to the lower end of the second movable-side plate portion 55. As shown in FIG. 10, the outer piece portion 56B-1 is formed to be shorter than the outer piece portion 46B-1, the upper piece portion 56B-2 is formed to be shorter than the upper piece portion 46B-2, the inner piece portion 56B-3 is formed to have substantially the same length as the inner piece portion 46B-3, and the lower piece portion 56B-4 is formed to be longer than the lower piece portion 56B-4. As shown in FIGS. 8A and 8B, the inner piece portion 56B-3 is formed such that its terminal width dimension of the intermediate portion in the vertical direction is smaller than that of the other portion, i.e., formed narrowly. As described above, by narrowing the width of the intermediate portion of the inner piece portion 56B-3, the inner piece portion 56B-3 is more easily elastically displaced.

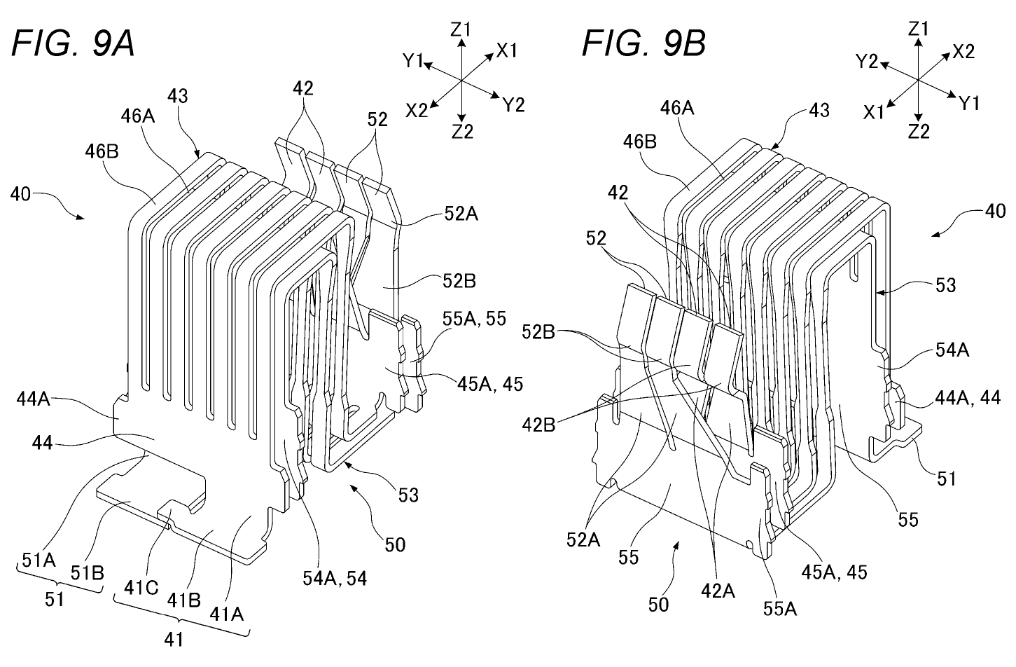

The first terminal 40 and the second terminal 50 constituting the terminal pair are disposed to overlap each other in the plate thickness direction. Specifically, the first terminal 40 is disposed so as to overlap the second terminal 50 from above. At this time, as shown in FIGS. 9A and 9B and FIGS. 11A, B, and C, the first terminal 40 and the second terminal 50 are located in the same range in the terminal width direction.

As shown in FIGS. 9A, 11A, and C, in the terminal pair, the second connection portion 51B is adjacent to the first connection portion 41B at a position on the Y1 side with respect to the first connection portion 41B, and comes into contact with the abutment piece portion 41C from below. As shown in FIG. 10, the second extension portion 51A is located in front of the first extension portion 41A.

As shown in FIG. 10, the second fixed-side plate portion 54 is spaced apart from the first fixed-side plate portion 44 in front of the first fixed-side plate portion 44. The second movable-side plate portion 55 is spaced apart from the first movable-side plate portion 45 in front of the first movable-side plate portion 45.

In the present embodiment, the first extending portion 42A extends inclinedly toward the Y1 side, and the second extending portion 52A extends inclinedly toward the Y2 side in the terminal width direction (Y-axis direction). Therefore, as shown in FIGS. 9A and 9B and FIGS. 11B and C, in the terminal pair, the first contact portion 42B is located closer to the Y1 side, and the second contact portion 52B is located closer to the Y2 side. As a result, the two first contact portions 42B and the two second contact portions 52B are arranged at equal intervals in the connector width direction. Since the first extending portion 42A is inclined at an angle larger than that of the second extending portion 52A in the connector width direction (X-axis direction), in the terminal pair, as shown in FIG. 10, the first contact portion 42B and the second contact portion 52B are disposed at the same position in the connector width direction and the vertical direction.

As shown in FIGS. 9B and 11B, in the terminal pair, the first extending portion 42A and the second extending portion 52A are disposed at positions partially overlapping each other when viewed in the plate thickness direction, i.e., the connector width direction. That is, in the first extending portion 42A, the lower-end-side portion can be formed with its terminal width dimension across a range extending to the second extending portion 52A in the terminal width direction. In the second extending portion 52A, the lower-end-side portion can be formed with its terminal width dimension across a range extending to the first extending portion 42A in the terminal width direction. Therefore, the base side portions of the first extending portion 42A and the second extending portion 52A can be maximally widened without enlarging the terminals 40 and 50 in the terminal width direction. As a result, since the maximum cross-sectional area can be secured in each base side portion, it is possible to flow a much larger current.

In the present embodiment, the slit 46A and the strip 46B of the first elastic portion 46 and the slit 56A and the strip 56B of the second elastic portion 56 are provided at the same position in the connector width direction in the same shape. Therefore, as shown in FIGS. 11A and C, when viewed in the vertical direction and the connector width direction, the slit 46A and the slit 56A are located to overlap each other, and the strip 46B and the strip 56B are located to overlap each other.

As shown in FIG. 10, in the second elastic portion 56, the outer piece portion 56B-1 is located inside the outer piece portion 46B-1 in the connector width direction. The upper piece portion 56B-2 is located below the upper piece portion 46B-2. The inner piece portion 56B-3 is located outside the inner piece portion 46B-3 in the connector width direction. The lower piece portion 56B-4 is located below the lower piece portion 46B-4. That is, the second elastic portion 56 is located with a gap from the first elastic portion 46 across the entire length. Therefore, when the first elastic portion 46 and the second elastic portion 56 are elastically displaced, the first elastic portion 46 and the second elastic portion 56 do not come into contact with each other.

The terminal pair of the terminal row on the X1 side and the terminal pair of the terminal row on the X2 side are disposed in an attitude rotated by 180 degrees about an axis extending in the vertical direction, i.e., in an attitude point-symmetrical to each other when viewed in the vertical direction, and face each other in the connector width direction (X-axis direction). At this time, the first contact portion 42B of the first terminal 40 on the X1 side and the second contact portion 52B of the second terminal 50 on the X2 side face each other, and the second contact portion 52B of the second terminal 50 on the X1 side and the first contact portion 42B of the first terminal 40 on the X2 side face each other (see FIG. 10). Therefore, in the connector fitting connection state, as shown in FIG. 12, the counterpart-side contact portion 83, described later, of the counterpart terminal 80 is sandwiched between the first contact portion 42B and the second contact portion 52B facing each other.

The fixing bracket 60 is formed by bending a metal plate member in the plate thickness direction. As shown in FIGS. 2 and 3, the fixing bracket 60 includes a base portion 61 having a plate surface perpendicular to the terminal arrangement direction and extending in the vertical direction, and a fixing portion 62 bent at the lower end of the base portion 61 and extending outward in the terminal arrangement direction. As shown in FIG. 3, the base portion 61 is press-fitted and held by the bracket holding portion 22A of the fixed housing 20 from below. The fixing portion 62 is disposed on and solder-connected to the corresponding portion (not shown) of the mounting surface of the circuit board, and fixed to the corresponding portion.

The connector 1 is assembled by attaching the first terminal 40 and the second terminal 50 to the housing 10 in this order, from below (the mounting surface side of the circuit board in the vertical direction), and then attaching the fixing bracket 60 to the housing 10. By attaching the first terminal 40 to the housing 10 prior to the second terminal 50 in this manner, the interference between the first terminal 40 and the second terminal 50 is avoided.

Specifically, first, the first movable-side held portion 45A is press-fitted into the first movable-side groove 32B from below, and the first terminal 40 is attached to the movable housing 30. Subsequently, the movable housing 30 is housed in the internal space 24 of the fixed housing 20 from below, and the edge portion 44A of the first terminal 40 is housed in the first fixed-side groove 21C of the fixed housing 20 from below.

Subsequently, the second fixed-side held portion 54A is press-fitted into the second fixed-side groove 21D from below, and the second movable-side held portion 55A is press-fitted into the second movable-side groove 32C from below to attach the second terminal 50 to the fixed housing 20 and the movable housing 30. At this time, the second connection portion 51B of the second leg portion 51 contacts and supports the abutment piece portion 41C of the first leg portion 41 from below, whereby the first connection portion 41B is excellently positioned in the vertical direction.

Next, the base portion 61 of the fixing bracket 60 is press-fitted into the bracket holding portion 22A of the fixed housing 20 from below to attach the fixing bracket 60 to the fixed housing 20. In this manner, the assembling operation of the connector 1 is completed.

The order of assembling the connector 1 is not limited to the order described above. For example, after the movable housing 30 is housed in the internal space 24 of the fixed housing 20, the first terminal 40 may be attached to the housing 10, and the second terminal 50 may be attached to the housing 10. The fixing bracket 60 may be attached to the fixed housing 20 before or simultaneously with the attachment of the terminals 40 and 50.

As shown in FIG. 1, the counterpart connector 2 includes a counterpart housing 70 and a plurality of counterpart terminals 80 arranged and held in the counterpart housing 70. In the present embodiment, two counterpart terminals 80 are provided. The counterpart housing 70 includes a main body portion 71 having a substantially rectangular parallelepiped outer shape that extends in one direction (Y-axis direction) parallel to the mounting surface of the circuit board, which is the long direction, and guided wall portions 72 extending downward from end portions on both sides of the main body portion 71 in the long direction.

As shown in FIG. 1, the main body portion 71 is formed by arranging a plurality of holding hole portions 71A holding the counterpart terminal 80 in the long direction. As shown in FIG. 12, the holding hole portion 71A vertically penetrates the main body portion 71 and press-holds the counterpart terminal 80. The guided wall portion 72 is formed with a guided groove 72A that is recessed from the inner surface on the inner side in the terminal arrangement direction and extends in the vertical direction. In the connector fitting process, the guided wall portion 72 receives the guide portion 36 of the connector 1 in the guided groove 72A from below and is guided into the internal space 24 of the fixed housing 20 by the guide portion 36.

The counterpart terminal 80 is formed by punching a metal plate member thicker than the terminals 40 and 50, and is disposed in an attitude in which its plate surface is perpendicular to the connector width direction. As shown in FIGS. 1 and 12, the counterpart terminal 80 includes a counterpart-side held portion 81 held by the holding hole portion 71A of the counterpart housing 70, a counterpart-side connection portion 82 extending upward from the counterpart-side held portion 81, and a counterpart-side contact portion 83 extending downward from the counterpart-side held portion 81.

The counterpart-side connection portion 82 is formed to have a terminal width dimension (dimension in the Y-axis direction) smaller than that of the counterpart-side held portion 81. The counterpart-side connection portion 82 has an upper end portion that extends upward from the counterpart housing 70 and is solder-connected to the circuit portion (not shown) of the circuit board at the upper end portion. The counterpart-side contact portion 83 is formed to have a terminal width dimension smaller than that of the counterpart-side held portion 81 and a terminal width dimension larger than that of the counterpart-side connection portion 82. The counterpart-side contact portion 83 extends downward from the counterpart-side held portion 81 to substantially the same position as the lower end of the guided wall portion 72. As shown in FIG. 12, the counterpart-side contact portion 83 comes into contact with the terminals 40 and 50 with the plate surface as a contact surface. In the present embodiment, the counterpart-side contact portions 83 are formed to have substantially the same width dimension as the terminals 40 and 50, and the two first contact portions 42B and the two second contact portions 52B come into contact with the respective contact surfaces.

The counterpart connector 2 is assembled by press-fitting the counterpart-side held portion 81 into the holding hole portion 71A of the counterpart housing 70 from above.

Next, a fitting connection operation between the connector 1 and the counterpart connector 2 will be described. First, the connector 1 is solder-connected and mounted on the mounting surface of a circuit board (not shown), and the counterpart connector 2 is solder-connected and mounted on the mounting surface of another circuit board (not shown). Subsequently, as shown in FIGS. 1 and 12, the connector 1 is disposed in an attitude in which the fitting portion 31 faces upward, and the counterpart connector 2 is disposed above the connector 1 in an attitude in which the counterpart-side contact portion 83 of the counterpart terminal 80 extends downward. The counterpart connector 2 is then moved downward to start the fitting connection operation with the connector 1.

In the connector fitting process, the guide portion 36 of the connector 1 enters the guided groove 72A of the counterpart connector 2 from below, guiding the guided wall portion 72 into the internal space 24. The counterpart-side contact portion 83 of the counterpart terminal 80 enters the receiving portion 34 of the connector 1, and further enters while spreading the space between the first contact portion 42B and the second contact portion 52B facing each other in the connector width direction. At this time, the first arm portion 42 and the second arm portion 52 are individually elastically displaced outward in the connector width direction, and as a result, further entry of the counterpart-side contact portion 83 is allowed.

When the connector fitting process proceeds and the connector 1 reaches the proper fitting position, as shown in FIG. 12, the connector 1 and the counterpart connector 2 are brought into the fitting connection state, and the connector fitting connection operation is completed. In the connector fitting connection state, the elastic displacement state of the first arm portion 42 and the second arm portion 52 is maintained, and the counterpart-side contact portion 83 comes into contact with the first contact portion 42B and the second contact portion 52B with a contact pressure. As a result, the terminals 40 and 50 and the counterpart terminal 80 are electrically conducted.

Immediately before the connectors 1 and 2 are fitted to each other or in the fitted connection state, the fitting position of the connector 1 into the counterpart connector 2 is not necessarily a normal position in the terminal arrangement direction and the connector width direction, and may be displaced in these directions. In the present embodiment, the deviation between the connectors 1 and 2 is absorbed by so-called floating in which the movable housing 30 moves, in the deviation direction under the elastic displacement of the elastic portions 46 and 56 of the terminals 40 and 50.

In the present embodiment, although the second fixed-side plate portion 54 of the second terminal 50 is held by the fixed housing 20, the first fixed-side plate portion 44 of the first terminal 40 is not held by the fixed housing 20. Therefore, in the first terminal 40, the first fixed-side plate portion 44 can be a portion that is elastically displaceable together with the first elastic portion 46. Therefore, as compared with the case in which the first fixed-side plate portion 44 is held by the fixed housing 20, it is possible to increase a so-called spring length, which is the length of the portion of the first terminal 40 that is elastically displaceable, and it is possible to secure a large floating amount of the movable housing 30. Since it is unnecessary to increase the entire length of the first terminal 40, it is possible to avoid increasing the size of the first terminal 40 and the connector 1.

In the embodiment described above, the first fixed-side plate portion 44 of the first terminal 40 is not held by the fixed housing 20, and the second fixed-side plate portion 54 of the second terminal 50 is held by the fixed housing 20. However, as an exemplary modification, the first fixed-side plate portion of the first terminal may be held by the fixed housing, and the second fixed-side plate portion of the second terminal may not be held by the fixed housing.

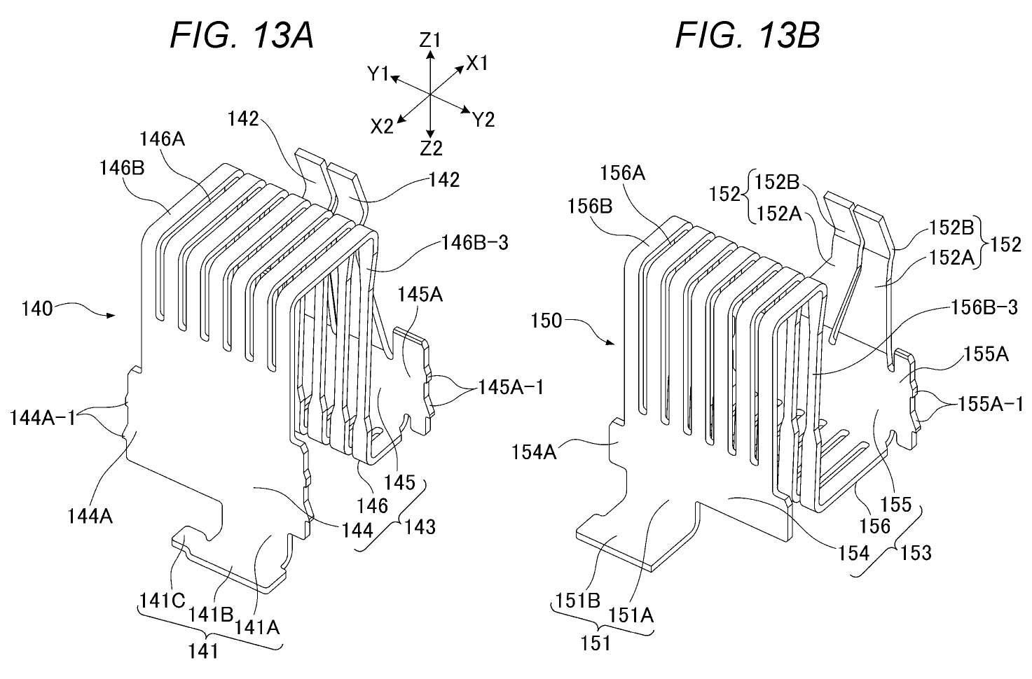

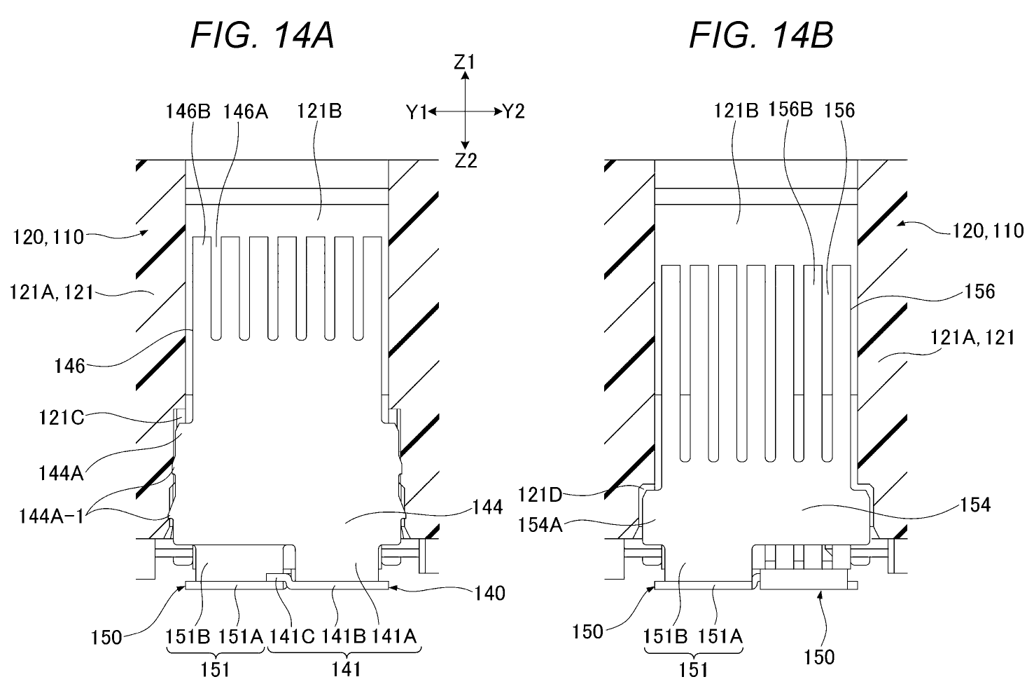

In the following, the exemplary modification will be described with reference to FIGS. 13A, 13B, 14A, and 14B. In FIGS. 13A, 13B, 14A, and 14B, the portions corresponding to the respective portions of the members in the above-described embodiment are denoted by reference numerals obtained by adding “100” to the reference numerals in the above-described embodiment described with reference to FIGS. 1 to 12. In this exemplary modification, portions different from those of the above-described embodiment will be mainly described, and the description of common portions will be omitted.

As shown in FIG. 13A, a first fixed-side plate portion 144 of a first terminal 140 has the same shape as the second fixed-side plate portion 54 (see FIGS. 8A and 8B) of the second terminal 50 of the embodiment described above. That is, both edge portions of the first fixed-side plate portion 144 in the terminal width direction are formed as a first fixed-side held portion 144A. As shown in FIG. 14A, the first fixed-side plate portion 144 is press-fitted and held in a first fixed-side groove 121C of a fixed housing 120 by a press-fit protrusion 144A-1 of the first fixed-side plate portion 144. As shown in FIG. 14A, the first fixed-side groove 121C has the same shape as the second fixed-side groove 21D of the above-described embodiment.

As shown in FIG. 13B, a second fixed-side plate portion 154 of a second terminal 150 has the same shape as the first fixed-side plate portion 44 (see FIGS. 7A and 7B) of the first terminal 40 of the embodiment described above. That is, both edge portions 154A of the second fixed-side plate portion 154 in the terminal width direction are housed in a second fixed-side groove 121D of the fixed housing 120, as shown in FIG. 14B. As shown in FIG. 14B, the second fixed-side groove 121D has the same shape as the first fixed-side groove 21C of the above-described embodiment. The edge portion 154A is housed in the second fixed-side groove 121D in a state where a gap is formed between the edge portion 154A and the inner surface of the second fixed-side groove 121D, and is displaceable within the range of the gap. In FIG. 14B, the illustration of the first terminal 140 shown in FIG. 14A is omitted.

In this exemplary modification, in the second terminal 150, the second fixed-side plate portion 154, in which the edge portion 154A is not held, can be a portion that is elastically displaceable together with a second elastic portion 156. Therefore, as compared with the case in which the second fixed-side plate portion 154 is held by the fixed housing 120, it is possible to increase a so-called spring length, which is the length of the portion of the second terminal 150 that is elastically displaceable, and it is possible to secure a large floating amount of a movable housing 130. Since it is unnecessary to increase the entire length of the second terminal 150, it is possible to avoid an increase in the size of the second terminal 150 and, in turn, the connector.

Also in this exemplary modification, when assembling the connector, the first terminal 140 and the second terminal 150 are attached to the housing 110 in this order from below. At this time, when the second terminal 150 is attached, since the first fixed-side plate portion 144 of the first terminal 140 is already held by the fixed housing 120. As shown in FIG. 14A, the lower surface of an abutment piece portion 141C of the first terminal 140 contacts and supports the upper surface of a second connection portion 151B of the second terminal 150 from above. Therefore, an excessive movement of a second leg portion 151 upward is restricted, and the second connection portion 151B is excellently positioned in the connector height direction.

In the embodiment and the exemplary modification described above, the first extending portions 42A and 142A of the first terminals 40 and 140 and the second extending portions 52A and 152A of the second terminals 50 and 150 extend such that the terminal width dimension decreases continuously toward the upper side. However, it is unnecessary for the terminal width dimension to be continuously reduced, and the terminal width dimension may be discontinuously reduced. In this case, for example, the first extending portions 42A and 142A and the second extending portions 52A and 152A may have step portions at side edges, and the terminal width dimension may decrease at the position of the step portion while going upward.

In the embodiment and the exemplary modification described above, both the first terminals 40 and 140 and the second terminals 50 and 150 are power supply terminals. However, it is unnecessary for both terminals to be power supply terminals. For example, at least one of the first terminal and the second terminal may be a signal terminal. Here, in a case in which one of the first terminal and the second terminal is used as a signal terminal and the other is used as a power supply terminal, the first terminal is not provided with an abutment piece portion in order to avoid contact between both terminals.

In the above-described embodiment and exemplary modification, two first extending portions 42A and 142A and two second extending portions 52A and 152A are provided. However, the number of the first extending portions and the number of the second extending portions are not limited to these, and may be one, three, or more.

In the embodiment and the exemplary modification described above, the slits 46A and slits 146A and the strips 46B and strips 146B are formed in the first elastic portion 46 and a first elastic portion 146, and the slits 56A and slits 156A and the strips 56B and strips 156B are formed in the second elastic portions 56 and 156. However, as long as sufficient elasticity can be secured in the first elastic portion and the second elastic portion, the slit and the strip are unnecessary, and the first elastic portion and the second elastic portion may be formed of one continuous belt-shaped portion in the terminal width direction. The slit and the strip may be formed only in one of the first elastic portion and the second elastic portion.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. An electrical connector for a circuit board, disposed on a mounting surface of the circuit board, to which a counterpart connector is fitted and connected, the electrical connector comprising:
a plurality of terminals having a shape in which a metal plate member is bent in a plate thickness direction and disposed in an attitude in which a plate thickness surface is perpendicular to the mounting surface; and
a housing that holds the plurality of terminals, in which the housing includes a fixed housing fixed to the circuit board via the terminal, and a movable housing relatively movable with respect to the fixed housing, wherein
the plurality of terminals includes a first terminal and a second terminal disposed so as to overlap the first terminal in the plate thickness direction,
the first terminal includes a first connection portion formed on one end side and connectable to a circuit portion of the circuit board, a first arm portion formed on another end side and contactable with the counterpart connector, and a first intermediate portion located between the first connection portion and the first arm portion,
the first intermediate portion includes a first fixed-side plate portion located on a fixed housing side, a first movable-side plate portion located on a movable housing side and held by the movable housing, and a first elastic portion that is elastically displaceable and couples the first fixed-side plate portion to the first movable-side plate portion,
the second terminal includes a second connection portion formed on one end side and connectable to the circuit portion of the circuit board, a second arm portion formed on another end side and contactable to the counterpart connector, and a second intermediate portion located between the second connection portion and the second arm portion and extending along the first intermediate portion,
the second intermediate portion includes a second fixed-side plate portion located on the fixed housing side, a second movable-side plate portion located on the movable housing side and held by the movable housing, and a second elastic portion that is elastically displaceable and couples the second fixed-side plate portion to the second movable-side plate portion, and
one of the first fixed-side plate portion and the second fixed-side plate portion is held by the fixed housing, and the other is not held by the fixed housing.

2. The electrical connector for a circuit board according to claim 1, wherein at least one of the first elastic portion and the second elastic portion has a plurality of strips arranged in a terminal width direction perpendicular to the plate thickness direction.

3. The electrical connector for a circuit board according to claim 1, wherein
the first terminal and the second terminal are press-fitted and held in the housing from the mounting surface side in a connector height direction perpendicular to the mounting surface,
the first elastic portion is located on a side opposite to the mounting surface with respect to the second elastic portion in the connector height direction,
the first connection portion and the second connection portion have a plate surface extending along the mounting surface of the circuit board, and are adjacent to each other in the terminal width direction,
the first connection portion includes an abutment piece portion extending toward the second connection portion in the terminal width direction, and
the abutment piece portion is located on a side opposite to the mounting surface in the connector height direction with respect to the second connection portion, and is allowed to abut on the second connection portion from the opposite side.

4. The electrical connector for a circuit board according to claim 2, wherein
the first terminal and the second terminal are press-fitted and held in the housing from the mounting surface side in a connector height direction perpendicular to the mounting surface,
the first elastic portion is located on a side opposite to the mounting surface with respect to the second elastic portion in the connector height direction,
the first connection portion and the second connection portion have a plate surface extending along the mounting surface of the circuit board, and are adjacent to each other in the terminal width direction,
the first connection portion includes an abutment piece portion extending toward the second connection portion in the terminal width direction, and
the abutment piece portion is located on a side opposite to the mounting surface in the connector height direction with respect to the second connection portion, and is allowed to abut on the second connection portion from the opposite side.
